(19) United States
(12) Patent Application Publication
(10) Pub. No.: US 2014/0201115 A1
(43) Pub. Date: Jul. 17, 2014

(54) DETERMINING SOFTWARE OBJECT RELATIONS USING NEURAL NETWORKS

(71) Applicants: Stefan Berndt, Speyer (DE); Mariusz Debowski, Sandhausen (DE)

(72) Inventors: Stefan Berndt, Speyer (DE); Mariusz Debowski, Sandhausen (DE)

(73) Assignee: SAP AG, Walldorf (DE)

(21) Appl. No.: 13/741,995

(22) Filed: Jan. 15, 2013

(51) Int. Cl. G06N 3/08

(52) U.S. Cl. CPC G06N 3/08
USPC 706/16

(57) ABSTRACT

A system receives runtime information from a plurality of software objects. The software objects include an executable, a modularization unit, and a data dictionary. The system executes a training phase in a software neural network using the runtime information. The software neural network generates a pattern among the executables, modularization units, and data dictionaries using the software neural network such that a particular executable is pattern-matched with one or more modularization units and one or more data dictionaries.

### TECHNICAL FIELD

The present disclosure relates to computer systems that include software objects, and in an embodiment, but not by way of limitation, a system and method for determining software object relations using neural networks.

### BACKGROUND

When operating business software systems, it may be important to understand relations between objects on different software layers. One method used to determine such relations is software modeling. Software modeling can provide static and general information about the relations between software objects. However, due to the flexible and various ways to configure such software systems, the ability to extend such software systems, and the complexity of such software systems, a static analysis is normally not sufficient to reliably describe the relations between software objects in actual business systems.

### BRIEF DESCRIPTION OF THE DRAWING

FIG. 1 is a block diagram of an example embodiment of a system for using a neural network for determining relations among software objects.

FIGS. 2A and 2B are a flowchart-like diagram illustrating steps and features of a system and method for using neural networks for determining relations among software objects.

FIG. 3 is a block diagram of an example embodiment of a computer system upon which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Due to the shortcomings of static analyses of business software systems as noted above, it would be desirable to implement an adaptive method of analyzing business software systems that could determine the actual (and potential) relations in a real business software system.

In an embodiment, an artificial/software neural network (ANN) and its algorithms can be used to determine the relations between software objects on different layers of a business software system. To do so, runtime information about the software objects in the system is collected from the business system. This information is used in the learning or training phase of the artificial neural network. Thereafter, the artificial neural network provides the information that is necessary to determine the relations between individual software objects in the system.

An artificial neural network is a mathematical model or a computational method that is based on a model of biological neural networks. This model is frequently used to reflect complex relationships between certain sets of data or to identify patterns in data. In most cases, an artificial neural network is an adaptive system. That is, it changes its response or output based on the available information. This adaption occurs during the training of the artificial neural network. Therefore, the artificial neural network is a system with the ability to update itself and learn according to the changing environment.

One or more embodiments using artificial neural networks have several advantages over the static methods of the prior art. For example, the use of an artificial neural network results in an adaptive method, and an adaptive method that describes real business software implementations and usage. Also, when using an artificial neural network, any changes implemented on the business system are automatically included in the results of any analysis. Additionally, dynamic relationships, i.e. runtime relationships, are included. Such inclusion of dynamic relationships is not possible when using static analysis. Furthermore, artificial neural networks work automatically on or in conjunction with the business system, and the artificial neural network does not adversely or negatively impact the operation of the business system. Additionally, the implementation and use of neural networks does not entail a great deal of effort on the part of the system support staff. And lastly, the use of an artificial neural network is a comprehensive method that covers the entire business software system.

Several embodiments of this disclosure can be used for conducting an impact analysis for an upcoming software change or upgrade. Also, an embodiment can be used to automatically assign custom developed software objects to business process steps in the system. The artificial neural network can also identify business functions that will affected by the blocking of access to modularization units and data dictionaries required by the software upgrade. Similarly, for archiving projects, the artificial neural network can identify business functions that are affected by table archiving.

In typical software-based systems, the processing of data is triggered by a number of events. These events are typically initiated by interactions with users (physical persons), by automatic system activities (e.g., scheduled jobs), or by other systems. These events can be referred to as transactions (person-initiated action), batch jobs (programs/reports executed as scheduled jobs on the system), or RFC calls (Remote Function Calls). Each of these actions (transactions, reports, or RFC calls) results in a sequence of program calls consisting of procedures, functions, and routines according to the calling flow of the business process. These procedures, functions, and routines operate on data. The transactions, reports, and RFC calls can be referred to as executables. The methods, function modules, and form routines can be referred to as modularization units. And the involved data can be referred to as data dictionary objects. Consequently, each executable is in relation with a set of modularization units and data dictionary objects. An executable can also be in relations with other executables.

For example, a user can start a report Ex1, which is an executable. The report Ex1 could call modularization, units MU1, MU2, MU3, and MU4, and the report could use data dictionary objects DD1, DD2, DD3, DD4, and DD5. This could be represented as a report R1 that is in relation with modularization units MU1, MU2, MU3, and MU4 and with data dictionary objects DD1, DD2, DD3, DD4 and DD5. It further could be represented as the following expression.

R1={Ex1, MU1, MU2, MU3, MU4, DD1, DD2, DD3, DD4, DD5}.

In a similar manner, another relation could; be identified and expressed as:

R2={Ex2, MU1, MU2, MU5, MU6, DD1, DD6, DD7, DD8, DD9}.

Based on these relations, it can be stated that MU1 is in relation with Ex1 as well as Ex2. However, DD6 is only in relation with Ex2 only and not with Ex1.

Even though the calling sequence can be uniquely determined for the execution of a certain segment of code, the relations are very complex and they depend on so many factors that the prediction of the exact list of procedures, functions, and routines that will be executed requires a considerable effort (e.g., individual tracing of the execution of each executable in an isolated environment). In contrast, the determination of the relations using an artificial neural network requires much less effort. While the relations determined by the artificial neural network may include less information than a full calling or trace flow, the information attained from the artificial neural network is quite sufficient for many analyses.

The knowledge of the relations of the executables with the modularization units and the data dictionary objects allows identification of the list of executables impacted by a set of modularization units and data dictionary objects that were or will be changed. This information allows one to predict the potential impact of such changes on the behavior of the whole system based on the knowledge of the changes to the modularization units and data dictionary objects.

In an embodiment, a method of utilizing artificial neural networks for the determination of relations between executables and modularization units and data dictionaries includes two steps. In a first step, information delivered by the continuous monitoring of the system trains the artificial neural network for pattern recognition. Specifically, in defined short time intervals, all executables are considered as input parameters to the artificial neural network. All modularization units and data dictionary objects, which were used in the same interval, are the output parameters (results). Since the correlation of the input and output level is deterministic, the artificial neural network establishes on its own the connection between the individual executable and a set of modularization units and data dictionary objects after a certain time and providing a sufficient number of measurement points. The exact duration and number of measurement points have to be established empirically depending on the required accuracy. As one of skill in the art knows, there are different artificial neural network algorithms that are available from different software vendors. One type of artificial neural network may be more appropriate for the patterning of a particular software system than another. The most appropriate neural network for a particular software system would have to be decided based on the capabilities of the neural network and the structure and function of the software system.

In a second step, a set of relations between each executable and modularization units and data dictionary objects is created. This means, when entering a certain executable as input to the artificial neural network, the called modularization units and data dictionary objects are provided as output. As a result, a list of all relations in the software system is available.

In another embodiment, the method can obtain inverse information. That is, starting with either a modularization unit or a data dictionary object, the neural network can determine which executable is in relation with the given modularization unit or a data dictionary object. This information can be then utilized, for example, for the determination of a list of executables that are affected by changes in a given subset of modularization units or data dictionary objects.

As another example, consider the following three relationships.

R1={Ex1, MU1, MU2, MU3, MU4, DD1, DD2, DD3}

R2={Ex2, MU1, MU2, MU5, MU6, DD7, DD8, DD9}

R3={Ex3, MU1, MU6, DD1, DD4, DD5, DD6, DD9}

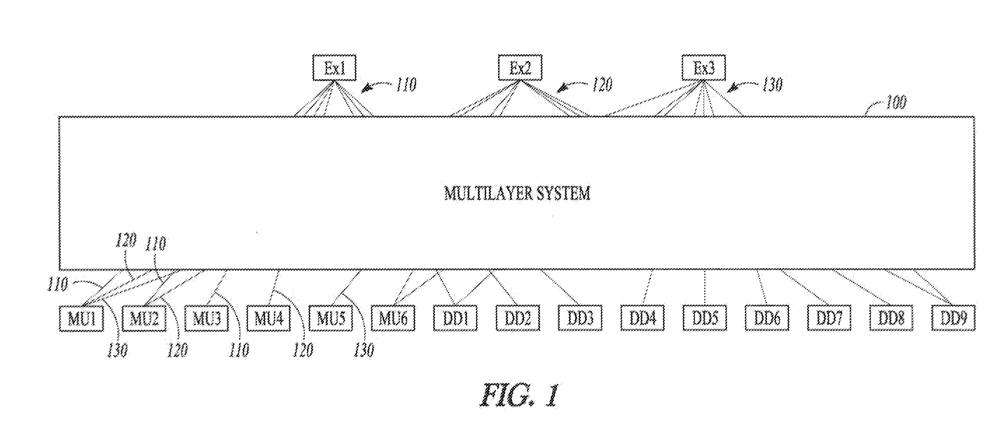

FIG. 1 illustrates the above relations as seen on the system. First, without the pattern matching of the artificial neural network, it is not possible to identify the executable that is in relation with DD2 for example. All that is known is that the executables Ex1, Ex2, and/or Ex3 are in some type of relation(s) with MU1-MU6 and DD1-DD9. However, if the pattern is known, the artificial neural network can determine for example that MU1 is in relation with all three executables (Ex1, Ex2, and Ex3; Nos. 110, 120, 130), that MU2 is in relation with only two of the executables (e.g., Ex1 and Ex2; Nos. 110, 120), and that MU3, MU4, and MU5 are each in relation with a single executable (e.g., Ex1, Ex2, and Ex3; Nos. 110, 120, and 130 respectively). In an embodiment, on a computer display device, the lines 110, 120, and 130 representing these relations can be color-coded such that Ex1, Ex2, and Ex3 each have their own colors (e.g., blue, red, green), and the relations to the modularization, units and data dictionaries are identified by these colors. For example, in such a configuration, the three lines coupled to MU1 would be blue, red, green; the two lines coupled to MU2 would be blue and red; and the single lines coupled to MU3, MU4, and MU5 would be blue, red, and green respectively.

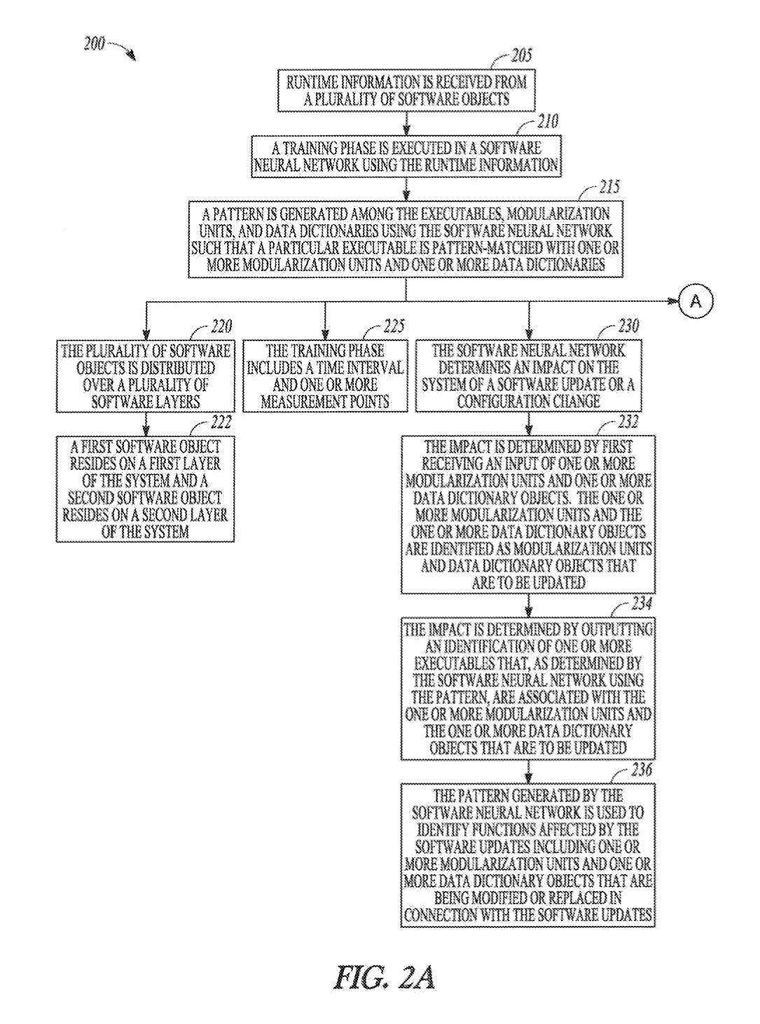

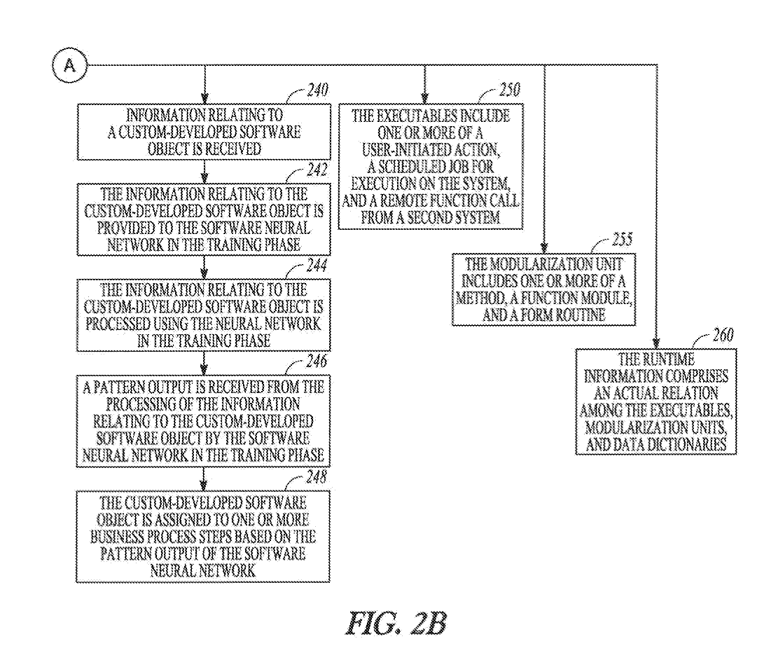

FIGS. 2A and 2B are a flowchart-like diagram of features and steps of an example process 200 for using an artificial/software neural network for determining relations among software objects. FIGS. 2A and 2B include a number of process blocks 205-260. Though arranged serially in the example of FIGS. 2A and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

At 205, runtime information is received from a plurality of software objects. The software objects include executables, modularization units, and data dictionaries. At 210, a training phase is executed in a software neural network using the runtime information. At 215, a pattern is generated among the executables, modularization units, and data dictionaries using the software neural network such that a particular executable is pattern-matched with one or more modularization units and one or more data dictionaries.

At 220, the plurality of software objects is distributed over a plurality of software layers, and as noted at 222, a first software object resides on a first layer of the system and a second software object resides on a second layer of the system.

At 225, the training phase includes a time interval and one or more measurement points. During the time interval, the executables are the input parameters to the software neural network, and the modularization units and data dictionaries that are used by the input parameter executables at the one or more measurement points are the output parameters of the software neural network.

At 230, the software neural network determines an impact on the system of a software update or a configuration change. As indicated at 232, this impact is determined by first receiving an input of one or mote modularization units and one or more data dictionary objects. The one or more modularization units and the one or more data dictionary objects are identified as modularization units and data dictionary objects that are to be updated. Secondly, as indicated at 234, this impact is determined by outputting an identification of one or more executables that, as determined by the software neural network using the pattern, are associated with the one or more modularization units and the one or more data dictionary objects that are to be updated. At 236, the pattern generated by the software neural network is used to identify functions affected by the software updates including one or move modularization units and one or more data dictionary objects that are being modified or replaced in connection with the software updates. During the software update process, which has a finite duration ranging from minutes to hours, the software update process requires exclusive access to the modularization units and data dictionaries that are being modified or replaced. Consequently, access to these modularization units and data dictionaries by users of the system will be limited or even blocked. However, by knowing the relations between the functions and the modularization units and data dictionaries, as determined by the artificial neural network, the software update's impact on the system can be predicted along with a prediction of which functions will have limited access or no access at all during the software update.

At 240, information relating to a custom-developed software object is received. At 242, the information relating to the custom-developed software object is provided to the software neural network in the training phase. At 244, the information relating to the custom-developed software object is processed using the neural network in the training phase. At 246, a pattern output is received from the processing of the information relating to the custom-developed software object by the software neural network in the training phase. At 248, the custom-developed software object is assigned to one or more business process steps based on the pattern output of the software neural network. Consequently, the system and method of using the artificial neural network can also be used to determine the relations of a new and/or custom-developed software object.

At 250, the executables include one or more of a user-initiated action, a scheduled job for execution on the system, and a remote function call from a second system.

At 255, the modularization unit includes one or more of a method, a function module, and a form routine.

At 260, the runtime information comprises an actual relation among the executables, modularization units, and data dictionaries. This is contrary to a static coding analysis, which would comprise a potential relation among the executables, modularization units, and data dictionaries. Specifically, in an embodiment, the runtime information distinguishes between potential relations and actual relations. A potential relation would include all modularization units and all data dictionaries that are used by a certain function regardless of the configuration and usage. The actual relation is derived from the actual usage of the system. For example, the software system could be designed to be used worldwide in connection with predicting weather. However, if the system is used in Australia, the portion of the system relating to the prediction of snowfall will never be used. That is, the runtime information would indicate that the portion of the system relating to snowfall is never executed in Australia. Therefore, updating the portion of the system relating to the prediction of snowfall could potentially affect the system, but due to the specific usage patterns in Australia as determined by the runtime information, there would be no impact on the system actually used in Australia.

Additional runtime information that can be used and/or considered in the training and/or execution of the artificial neural network might include information about active users on the system, interface usage patterns, and use of hardware resources such as CPU time and memory resources.

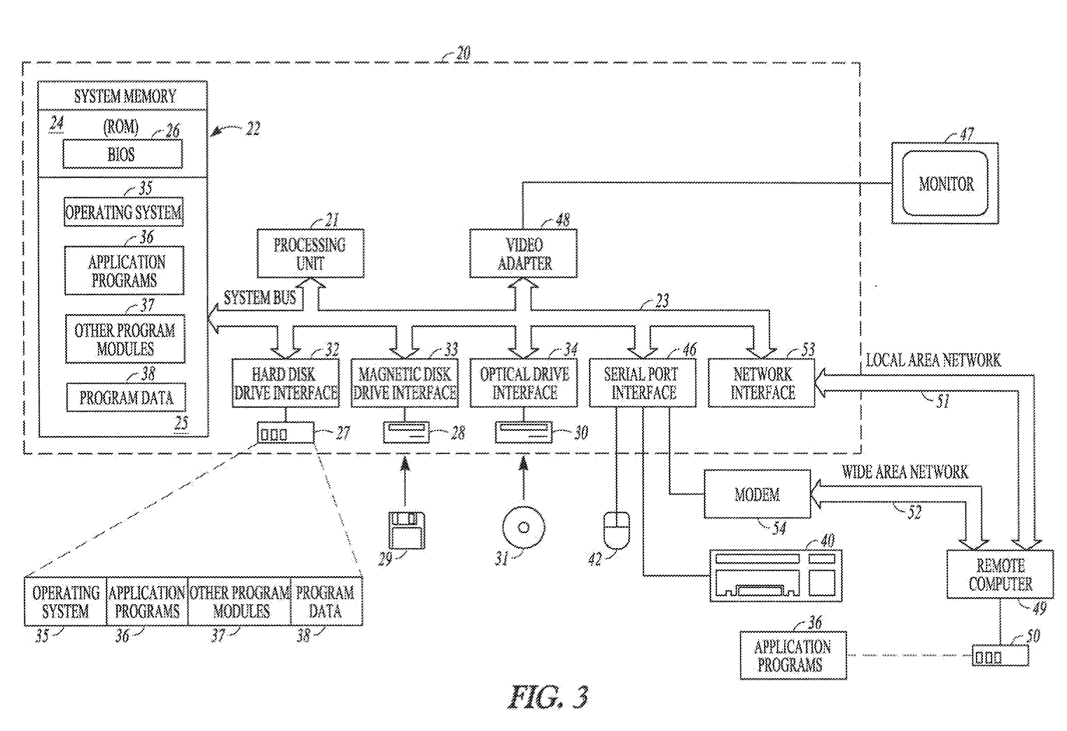

FIG. 3 is an overview diagram of a hardware and operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to die processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for die user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Thus, an example system, method and machine readable medium for using software neural networks for determining relations among software objects have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor operable to:
receive runtime information from a plurality of software objects, the software objects comprising an executable, a modularization unit, and a data dictionary;
execute a training phase in a software neural network using the runtime information; and
generate a pattern among the executables, modularization units, and data dictionaries using the software neural network such that a particular executable is pattern-matched with one or more modularization units and one or more data dictionaries.

2. The system of claim 1, wherein the plurality of software objects is distributed over a plurality of software layers.

3. The system of claim 2, wherein a first software object resides on a first layer of the system and a second software object resides on a second layer of the system.

4. The system of claim 1, wherein the training phase comprises a time interval and one or more measurement points, and wherein during the time interval the executables comprise input parameters to the software neural network, and the modularization units and data dictionaries used by the input parameter executables at the one or more measurement points comprise output parameters of the software neural network.

5. The system of claim 1, wherein the computer processor and software neural network are operable to determine an impact of a software update or a configuration change by:
receiving an input of one or more modularization units and one or more data dictionary objects, wherein the one or more modularization units and the one or more data dictionary objects are identified as modularization units and data dictionary objects that are to be updated; and
outputting an identification of one or more executables that, as determined by the software neural network using the pattern, are associated with the one or more modularization units and the one or more data dictionary objects, that are to be updated.

6. The system of claim 5, wherein the pattern generated by the software neural network is used to identify functions affected by the software updates including one or more modularization units and one or more data dictionary objects that are being modified or replaced in connection with the software updates.

7. The system of claim 1, wherein the computer processor and software neural network are operable to:
receive information relating to a custom-developed software object;
provide the information relating to the custom-developed software object to the software neural network in the training phase;
process the information relating to the custom-developed software object using the neural network in the training phase;
receive a pattern output from the processing of the information relating to the custom-developed software object by the software neural network in the training phase; and
assign the custom-developed software object to one or more business process steps based on the pattern output of the software neural network.

8. The system of claim 1, wherein the executable comprises one or more of a user-initiated action, a scheduled job for execution on the system, and a remote function call from a second system.

9. The system of claim 1, wherein the modularization unit comprises one or more of a method, a function module, and a form routine.

10. The system of claim 1, wherein the runtime information comprises a potential relation among the executables, modularization units, and data dictionaries and an actual relation among the executables, modularization units, and data dictionaries.

11. A process comprising:
receiving runtime information from a plurality of software objects, the software objects comprising an executable, a modularization unit, and a data dictionary;
executing a training phase in a software neural network using the runtime information; and
generating a pattern among the executables, modularization units, and data dictionaries using the software neural network such that a particular executable is pattern-matched with one or more modularization units and one or more data dictionaries.

12. The process of claim 11, wherein the plurality of software objects is distributed over a plurality of software layers.

13. The process of claim 11, wherein the training phase comprises a time interval and one or more measurement points, and wherein during the time interval the executables comprise input parameters to the software neural network, and the modularization units and data dictionaries used by the input parameter executables at the one or more measurement points comprise output parameters of the software neural network.

14. The process of claim 11, comprising:
receiving an input of one or more modularization units and one or more data dictionary objects, wherein the one or more modularization units and the one or more data dictionary objects are identified as modularization units and data dictionary objects that are to be updated; and
outputting an identification of one or more executables that, as determined by the software neural network using the pattern, are associated with the one or more modularization units and the one or more data dictionary objects that are to be updated;
wherein the pattern generated by the software neural network is used to identify functions affected by the software updates including one or more modularization units and one or more data dictionary objects that are being modified or replaced in connection with the software updates.

15. The process of claim 11, comprising:
receiving information relating to a custom-developed software object;
providing the information relating to the custom-developed software object to the software neural network in the training phase;
processing the information relating to the custom-developed software object using the neural network in the training phase;
receiving a pattern output from the processing of the information relating to the custom-developed software object by the software neural network in the training phase; and
assigning the custom-developed software object to one or more business process steps based on the pattern output of the software neural network.

16. A computer readable medium comprising instructions that when executed by a processor execute a process comprising:
receiving runtime information from a plurality of software objects, the software objects comprising an executable, a modularization unit, and a data dictionary;
executing a training phase in a software neural network using the runtime information; and
generating a pattern among the executables, modularization units, and data dictionaries using the software neural network such that a particular executable is pattern-matched with one or more modularization units and one or more data dictionaries.

17. The computer readable medium of claim 16, wherein the plurality of software objects is distributed over a plurality of software layers.

18. The computer readable medium of claim 16, wherein the training phase comprises a time interval and one or more measurement points, and wherein during the time interval the executables comprise input parameters to the software neural network, and the modularization units and data dictionaries used by the input parameter executables at the one or more measurement points comprise output parameters of the software neural network.

19. The computer readable medium of claim 16, comprising instructions for executing a process comprising:
receiving an input of one or more modularization units and one or more data dictionary objects, wherein the one or more modularization units and the one or more data dictionary objects are identified as modularization units and data dictionary objects that are to be updated; and
outputting an identification of one or more executables that, as determined by the software neural network using the pattern, are associated with the one or more modularization units and the one or more data dictionary objects that are to be updated;
wherein the pattern generated by the software neural network is used to identify functions affected by the software updates including one or more modularization units and one or more data dictionary objects that are being modified or replaced in connection with the software updates.

20. The computer readable medium of claim 16, comprising instructions for executing a process comprising:
receiving information relating to a custom-developed software object;
providing the information relating to the custom-developed software object to the software neural network in the training phase;
processing the information relating to the custom-developed software object using the neural network in the training phase;
receiving a pattern output from the processing of the information relating to the custom-developed software object by the software neural network in the training phase; and
assigning the custom-developed software object to one or more business process steps based on the pattern output of the software neural network.
